(19) United States
(12) Patent Application Publication
(10) Pub. No.: US 2006/0102231 A1
(43) Pub. Date: May 18, 2006

(54) DISPENSER CARRIER ASSEMBLY

(76) Inventors: Steven E. Schiller, Kenosha, WI (US); Robert T. Ryer, Madison, WI (US); Christopher F. Lang, Burlington, WI (US); Daniel T. Dub, Racine, WI (US); Michael H. Bertucci, Gurnee, IL (US)

Correspondence Address: S.C. JOHNSON COMMERCIAL MARKETS INC, 8310 16TH STREET, M/S 510, PO BOX 902, STURTEVANT, WI, 53177-0902, US

(21) Appl. No.: 10/904,499

(22) Filed: Nov. 12, 2004

(51) Int. Cl. A01M 7/00; B65H 75/40

(52) U.S. Cl. 137/355.12; 137/355.2; 242/395; 242/400; 242/403

(57) ABSTRACT

A carrier assembly or cart which affords a portable source of water to allow the dispensing of cleaning chemicals over a large area. The cart also includes compartments for the placement of dispensing devices as well as the attachment for cleaning devices such as brooms, a mop bucket and a waste receptacle. The cart is constructed in a unitary and compact manner.

### BACKGROUND OF THE INVENTION

This invention relates to an assembly for transporting dispensing devices. More particularly, it relates to a cart for transporting a hose reel and a liquid dispensing device for cleaning and disinfecting agents.

Wheeled carriers for hose reels are well-known. They are described in U.S. Pat. No. 2,640,724; U.S. Pat. No. 5,462,298; U.S. Pat. No. 5,626,307 and U.S. Pat. No. 6,338,360. In U.S. Pat. No. 2,640,724 a spray gun 16 is connected to a hose 15 mounted on a hose reel 30. Several tanks are provided to supply liquids to the spray gun. U.S. Pat. No. 5,462,298; U.S. Pat. No. 5,626,307 and U.S. Pat. No. 6,338,360 do not disclose dispensing devices in combination with a hose reel on a cart. There is a need to provide portability to dispensing devices which dispense liquid cleaning materials including disinfectants. The type of dispensing device concerned with in this invention is described in U.S. Pat. No. 6,708,901, which teachings are incorporated by reference. This type of dispenser is employed with a source of pressurized water.

### SUMMARY OF THE INVENTION

The present invention provides a carrier assembly for transporting liquid dispensing devices. A frame structure has at least one wheel member and a handle member connected thereto. There is at least one panel member constructed and arranged to support a dispensing device. A hose reel is connected to the frame structure and includes a first length of hose. A second length of flexible hose is connected to the first length of hose, the second length of hose adapted to be connected to the liquid dispensing device.

In one aspect the hose reel is connected to the panel member.

In a preferred embodiment, there are two panel members, one positioned above the other. One panel member constitutes an upper panel member and the other constitutes a lower panel member. The hose reel is connected to the upper panel member.

In another preferred embodiment, the upper and lower panel members have pocket members for accommodating dispensing devices.

In yet another preferred embodiment, the upper and lower panel members are interconnected with a compartment for the second length of flexible tubing.

In still another preferred embodiment the carrier assembly is constructed to transport cleaning implements such as mops and brushes as well as buckets.

A general object of the invention is to provide a portable carrier assembly or cart for dispensing devices.

Another object of the invention is to provide a carrier assembly or cart which has a source of water, pockets for accommodating dispensing devices and a connection of the dispensing devices to the source of water.

Yet another object is a carrier assembly of the foregoing type which can accommodate a wide variety of cleaning devices.

Still another object is a carrier assembly of the foregoing type which is aesthetically appearing.

Yet another object is a carrier assembly of the foregoing type which is structurally durable.

### BRIEF DESCRIPTION OF THE DRAWINGS

FIG. 1 is a front perspective view of the dispenser carrier assembly of the invention;

FIG. 2 is a rear perspective view of the dispenser carrier assembly shown in FIG. 1;

FIG. 3 is a view similar to FIG. 2 showing the placement of dispensing devices and other articles thereon;

FIG. 4 is a front view of the dispenser carrier assembly shown in FIGS. 1-3;

FIG. 5 is a back view of the dispenser carrier shown in FIGS. 1-3;

FIG. 6 is a bottom view of the dispenser carrier shown in FIGS. 1-3; and

FIG. 7 is a front perspective view of another embodiment of the dispenser assembly.

### DESCRIPTION OF THE PREFERRED EMBODIMENTS

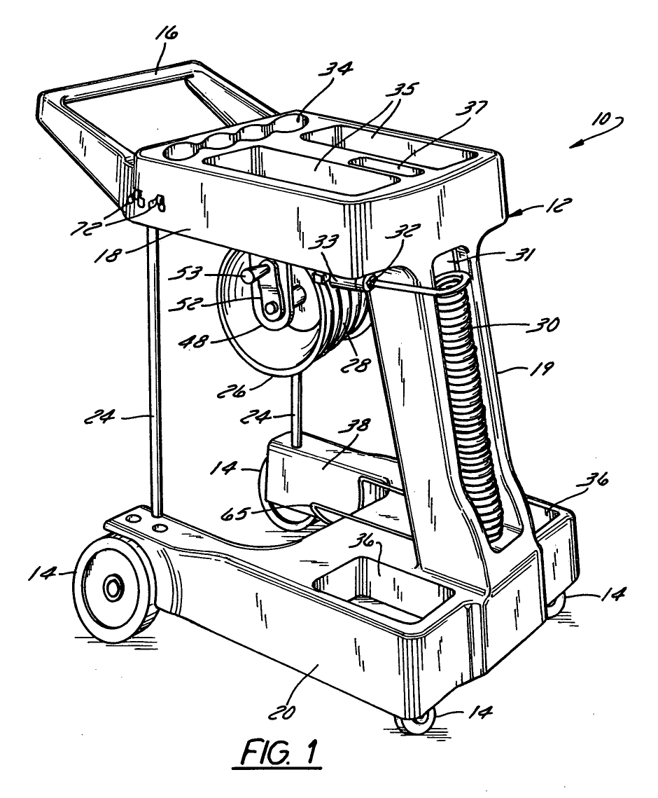

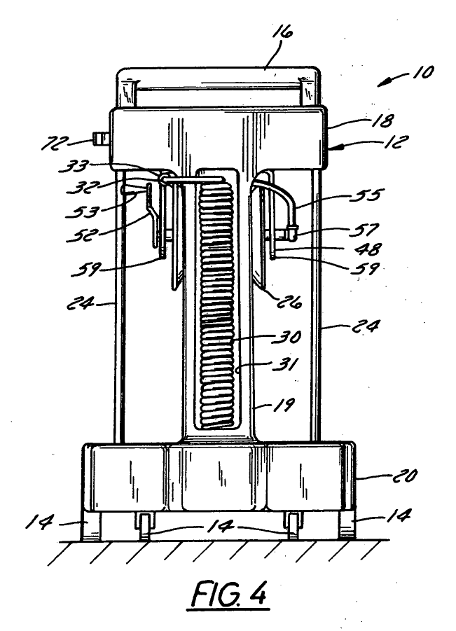

Referring to FIGS. 1-4, the carrier assembly generally 10 includes a frame structure 12 supported on wheel members 14. It has a handle member 16 as well as panel members 18, 19 and 20 which compose the frame structure. Upper panel member 18 and lower panel member 20 are connected by the support rods 24. A hose reel 26 with hose 28 is disposed beneath upper panel member 18. A compartment 31 is provided in panel member 19 and accommodates coiled hose 30. A connect-disconnect device 32 is provided at the end of the coiled hose 30 and is retained in holder 33. The carrier assembly 10 has several pockets, 34, 35 and 36 to accommodate dispensing devices 40, 41 and 42. Pocket 37 accommodates a spray nozzle (not shown).

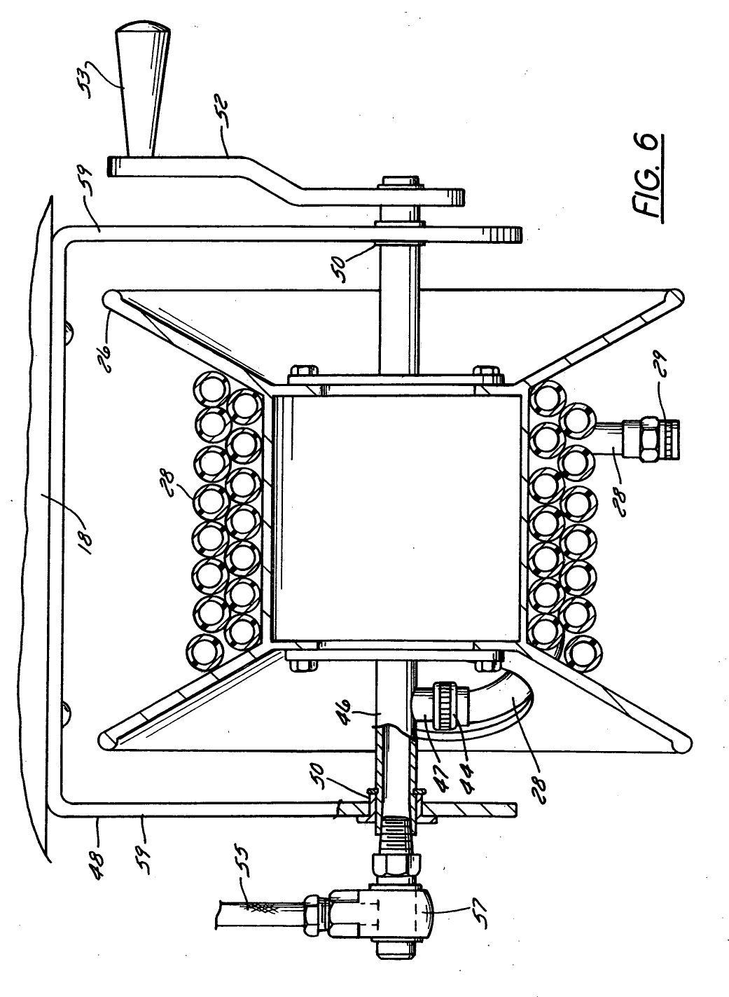

Referring to FIG. 6, it is seen that hose reel 26 is supported from panel member 18 by bracket 48. A conduit 46 extends through the end plates 59 of bracket 48 and is rotatably mounted in the bracket 48 by means of the bearings 50. A connection 44, as well as pipe section 47 connects the hose 28 to the conduit 46. A connection 57 affords a leak tight and rotatable mounting of flexible conduit 55 to the conduit 46. A crank member 52 with handle 53 allows for the rotation of the hose reel.

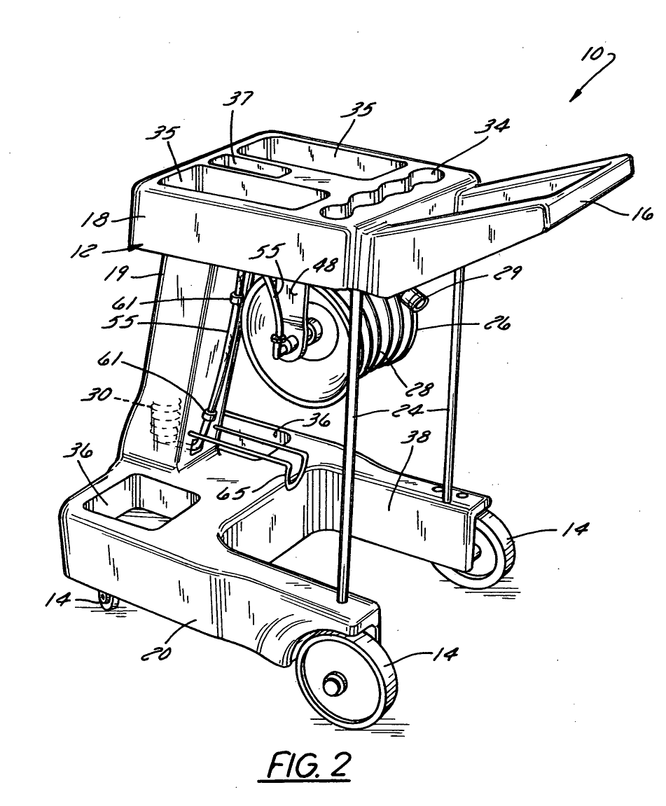

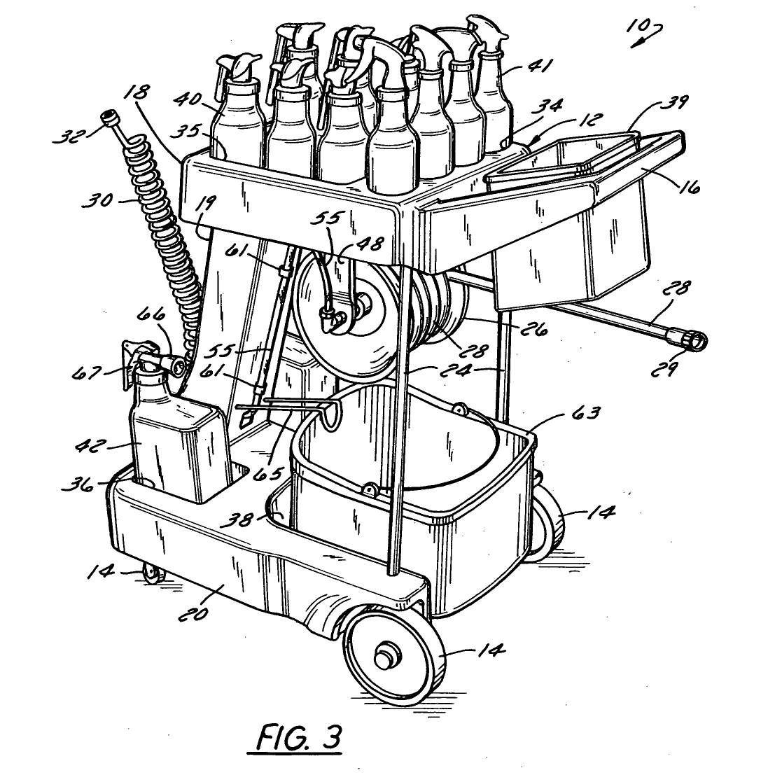

As seen in FIGS. 2 and 3, flexible conduit 55 is retained on the panel member 19 by the connections 61. Flexible conduit 55 is connected to coiled hose 30 as illustrated in FIG. 2.

As seen in FIG. 3, panel member 20 has a cavity section 38 which accommodates mop bucket 63. It is retained in the cavity 38 by the retainer 65 connected to panel member 19. In this instance, the mop bucket 63 will have wheels (not shown) on the bottom so as to be moved along with the carrier assembly 10.

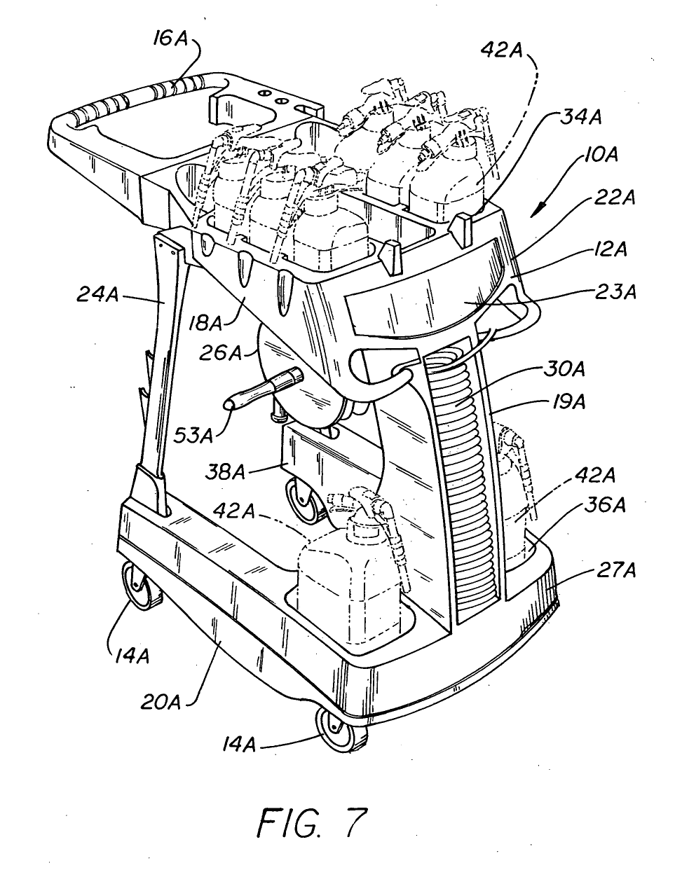

Another embodiment of the carrier assembly is shown in FIG. 7. Similar parts are designated with similar numbers as previously employed except followed with the suffix “A”. Carrier assembly generally 10A differs from assembly 10 in the different configurations of the frame structure 12A such as the panel members 18A, 19A and 20A. Frame structure 2A includes a front panel 22A with an identification portion 23A. A curved front portion 27A is also provided in frame structure 12A. Panel member 19A is also curved. The size of support rods 24A has also been increased. Instead of hand activated dispensing device 40 being placed in the pockets 34A as in assembly 10, the hose end dispensing device 42A is placed therein.

Operation

A better understanding of the carrier assembly 10 will be had the by a description of its operation.

Referring to FIG. 3, hose 28 will be connected to a suitable source of water pressure such as by the connector 29. The cart can then be moved to any section of an area which is to be cleaned with the un-reeling of the hose 28 from the hose reel 26. A dispensing device 42 can then be connected to coiled hose 30 by means of the connect-disconnect 32 for connection with the head connector 66.

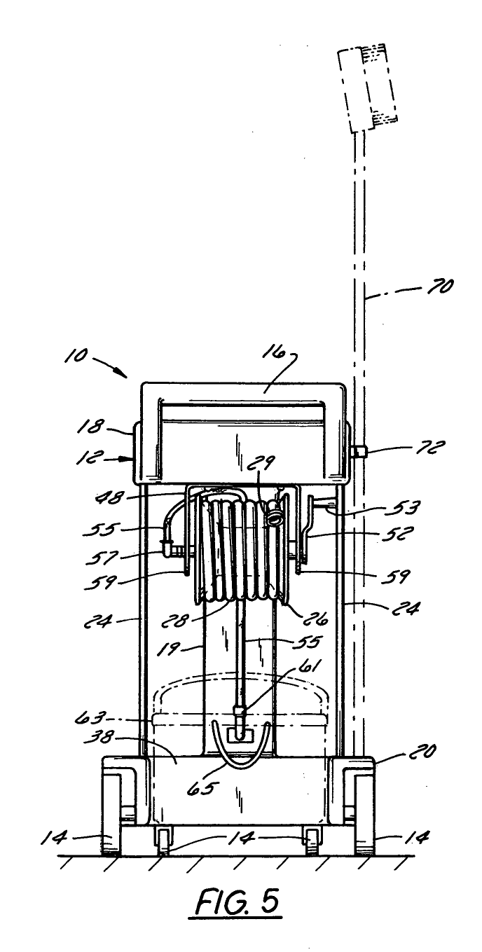

Dispensing device 42 in this instance is described in U.S. Pat. No. 6,708,901. This dispensing device 42 includes a dispensing head 67, with a slideable and rotatable eductor. Water will flow through hose 28, flexible conduit 55 and flexible hose 30 to the head connector 66 and head 67. If it is desired to utilize a hand-type dispenser, such as shown at 40 or 41, these are readily available. The mop bucket 63 affords ready access to a mop should this function be desired. Further, as seen in FIG. 5, a mop brush 70 is available when connected by the clasp 72 to the carrier assembly 10. In a similar manner a squeegee device (not shown) can also be attached.

It will be seen that there is now provided a convenient and portable source of water for use in a dispensing device which allows for convenient cleaning of a wide area, limited only by the length of the hose 28. Suitable auxiliary cleaning dispensing devices 40 and 41 are carried by the carrier assembly as well as receptacle container 39 inside the handle member.

A preferred material for fabricating the carrier assembly is molded plastic such as polyethylene, however other suitable plastic materials such as low density polyethylene, high density polyethylene, polyvinylchloride, polypropylene or nylon could also be employed. The carrier assembly 10 has been described for use with several types of dispensing devices. Many of these can be eliminated and still carry out the basic function of portability of the carrier assembly. Neither is it necessary to have the receptacle 39, the mop bucket 63 and the dispensing devices 40 and 41. All such and other modifications within the spirit of the invention are meant to be within a scope as defined by the appended claims.

What is claimed is:

1. A carrier assembly for transporting liquid dispensing devices comprising:
a frame structure;
at least one wheel member and a handle member connected to the frame structure;
at least one panel member constructed and arranged to support a dispensing device;
a hose reel connected to the frame structure and including a first length of hose;
a second length of flexible hose connected to the first length of hose, the second length of hose adapted to be connected to the liquid dispensing device.

2. The carrier assembly as defined in claim 1 wherein the hose reel is connected to the panel member.

3. The carrier assembly as defined in claim 1 wherein there are two panel members, one positioned above the other, one panel member constituting an upper panel member and the other constituting a lower panel member, the hose reel being connected to the upper panel member.

4. The carrier assembly as defined in claim 3 wherein the upper and lower panel members have pocket members for accommodating dispensing devices.

5. The carrier assembly as defined in claim 3 wherein the upper and lower panel members are interconnected with a compartment for the second length of flexible tubing.

6. The carrier assembly as defined in claim 5 wherein the lower panel member includes a cavity section for accommodating a mop bucket.

7. The carrier assembly as defined in claim 6 further including a retainer member connected to the frame structure and the mop bucket.

8. The carrier assembly as defined in claim 1 further including a compartment with the second length of flexible tubing being accommodated therein.

9. The carrier assembly as defined in claim 1 further including a hose connect/disconnect device for connecting the dispensing device to the second length of hose.

10. The carrier assembly as defined in claim 1 wherein the liquid dispensing device includes an eductor.

11. The carrier assembly as defined in claim 10 wherein the eductor is both slideable and rotatable.

12. The carrier assembly as defined in claim 1 wherein the frame structure and the panel member is composed of molded plastic.

13. The carrier assembly as defined in claim 1 wherein the handle member is constructed and arranged to support a receptacle.

14. The carrier assembly as defined in claim 1 wherein the frame structure includes a clasp member for connection to a handle of a cleaning device.
